(19) United States
(12) Patent Application Publication
(10) Pub. No.: US 2020/0358150 A1
(43) Pub. Date: Nov. 12, 2020

(54) SYSTEM FOR THERMAL MANAGEMENT OF A BATTERY

(71) Applicant: Cummins Inc., Columbus, IN (US)

(72) Inventors: William B. Fields, Seymour, IN (US); Patrick Sill, Indianapolis, IN (US); Subbarao Varigonda, Columbus, IN (US)

(21) Appl. No.: 16/962,693

(22) PCT Filed: Feb. 1, 2019
(86) PCT No.: PCT/US2019/016343

§ 371 Date: Jul. 16, 2020

Related U.S. Application Data
(60) Provisional application No. 62/625,423, filed on Feb. 2, 2018.

(51) Int. Cl. H01M 10/65; B60L 58/24; B60L 50/60; H01M 10/625; H01M 10/63; H01M 2/10

(52) U.S. Cl. CPC H01M 10/65; B60L 58/24; B60L 50/66; B60K 6/28; H01M 10/63; H01M 2/1072; H01M 10/625

(57) ABSTRACT

A system for controlling external thermal loads on at least one battery for a vehicle includes a battery enclosure configured to support the at least one battery external to the vehicle. The enclosure includes a thermally-reactive portion.

### CROSS REFERENCE TO RELATED APPLICATIONS

The present application claims the benefit under Title 35, U.S.C. § 119(e) of U.S. Provisional Patent Application Ser. No. 62/625,423, entitled SYSTEM FOR THERMAL MANAGEMENT OF A BATTERY, filed on Feb. 2, 2018, the entire disclosure of which is expressly incorporated by reference herein.

### TECHNICAL FIELD

The present disclosure relates generally to managing the temperature of a battery for a vehicle and, more particularly, to a system and method of controlling and managing external thermal loads applied to an externally-mounted battery on a vehicle.

### BACKGROUND OF THE DISCLOSURE

Large-scale and/or cargo vehicles, for example passenger busses, semi-trucks or trailers, or other types of vehicle configured to carry large numbers of people and/or heavy cargo, are configured to maximize the available interior space for people and/or cargo. As such, various vehicle components, such as batteries, air handling systems, and other components, may be supported on an external surface of the vehicle, rather than occupy space internally where passengers and cargo may be. More particularly, such components may be supported on the vehicle at a location external to the vehicle frame and body panels. For example, batteries and other vehicle components may be supported at the rear of the vehicle and/or on the roof of the vehicle. Unlike automobiles and other vehicles for personal consumer use, which are aesthetically designed and configured to conceal a majority of vehicle components, commercial and/or cargo vehicles require increased vehicle capacity for passengers and/or cargo and may be less concerned with aesthetics of the vehicle in an effort to maximize cargo and passenger space, thereby requiring that certain vehicle components are supported externally to the vehicle interior space.

In instances where the vehicle is configured as a hybrid vehicle, a range-extended vehicle, or an electric vehicle, the number and/or size of the batteries required to operate the vehicle may be increased relative to an automobile or other vehicle operated solely by a fuel-based engine. As such, there may be additional requirements for cooling such a large number of batteries and/or larger-scale batteries. More particularly, if the batteries are supported externally to the vehicle body, then the batteries may be exposed to high thermal loads, for example through sun-loading, when exposed to sunlight, which may increase the temperature of the batteries above an optimal working temperature range. Conversely, the batteries may be exposed to low thermal loads, for example through cold temperatures and/or conditions, which may decrease the temperature of the batteries below an optimal working temperature range. Therefore, such externally-mounted batteries on hybrid and/or electric vehicles may experience temperature changes due to both the operation of the battery itself and other vehicle components adjacent the battery and also from external temperature loads due to the external positioning of the battery on the vehicle. In this way, there is a need for a thermal management device, apparatus, system, and/or method for managing the temperature of externally-mounted batteries on a vehicle.

### SUMMARY OF THE DISCLOSURE

In one embodiment of the present disclosure, a system for controlling external thermal loads on at least one battery for a vehicle comprises a battery enclosure configured to support the at least one battery external to the vehicle. The enclosure includes a thermally-reactive portion.

In another embodiment of the present disclosure, a system for controlling external thermal loads on at least one battery for a vehicle comprises a battery enclosure configured to support the at least one battery external to the vehicle. The enclosure includes a thermally-reactive portion. Additionally, the system comprises a control system comprising a controller and at least one sensor operably coupled to the controller and the battery enclosure. The controller is configured to adjust a parameter of the thermally-reactive portion of the battery enclosure.

In a further embodiment of the present disclosure, a method of controlling external thermal loads on at least one battery for a vehicle comprises providing an enclosure for the at least one battery, supporting the enclosure on an external portion of the vehicle, providing a thermally-reactive portion of the enclosure, and managing external thermal loads on the at least one battery with the thermally-reactive portion.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein;

FIG. 1 is a perspective view of a hybrid, range-extended, or electric vehicle configured to carry passengers and/or cargo and including an external battery enclosure for supporting batteries external to the vehicle;

FIG. 2 is a schematic view of a control system configured to manage external thermal loads on the batteries of FIG. 1;

FIG. 3A is a top view of the vehicle of FIG. 1 including a thermally-reactive portion of the battery enclosure defining a dark-colored surface finish or treatment of a portion of the battery enclosure;

FIG. 3B is a top view of the vehicle of FIG. 1 including the thermally-reactive portion of the battery enclosure defining a light-colored or reflective surface finish or treatment of the portion of the battery enclosure;

FIG. 4A is a top view of the vehicle of FIG. 1 including the thermally-reactive portion of the battery enclosure defining a plurality of thermally-activated louvers in a closed position;

FIG. 4B is a cross-sectional view of thermally-activated louvers of FIG. 4A in the closed position;

FIG. 5A is a top view of the vehicle of FIG. 4A including the thermally-activated louvers in an open position;

FIG. 5B is a cross-sectional view of thermally-activated louvers of FIG. 5A in the closed position;

FIG. 6A is a top view of the vehicle of FIG. 1 including the thermally-reactive portion of the battery enclosure defining at least one thermally-activated window in a transparent mode;

FIG. 6B is a top view of the vehicle of FIG. 6A including the at least one thermally-activated window in an opaque mode; and

FIG. 7 is a flowchart of an illustrative method of managing or controlling external thermal loads on the batteries of FIG. 1.

Although the drawings represent embodiments of the various features and components according to the present disclosure, the drawings are not necessarily to scale and certain features may be exaggerated in order to better illustrate and explain the present disclosure. The exemplification set out herein illustrates embodiments of the disclosure, and such exemplifications are not to be construed as limiting the scope of the disclosure in any manner.

### DETAILED DESCRIPTION OF THE DRAWINGS

For the purpose of promoting an understanding of the principles of the disclosure, reference will now be made to the embodiments illustrated in the drawings, which are described below. It will nevertheless be understood that no limitation of the scope of the disclosure is thereby intended. The disclosure includes any alterations and further modifications in the illustrated device and described methods and further applications of the principles of the disclosure, which would normally occur to one skilled in the art to which the disclosure relates. Moreover, the embodiments were selected for description to enable one of ordinary skill in the art to practice the disclosure.

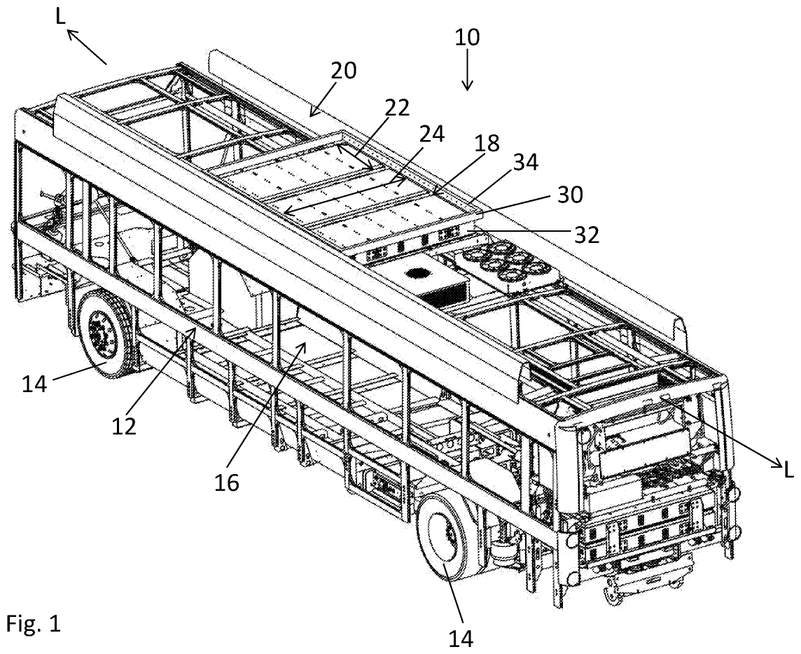

Referring to FIG. 1, an illustrative vehicle 10 is shown. Vehicle 10 is configured as a commercial or cargo vehicle configured to carry large numbers of passengers and/or cargo. Illustratively, vehicle 10 is configured as a commercial passenger bus configured to carry more passengers than an automobile or other vehicle for personal consumer use. Vehicle 10 includes a frame assembly 12 supported by a plurality of ground-engaging members 14, such as front and rear wheels. Frame assembly 12 extends between front and rear ends of vehicle 10 along a longitudinal axis L. Frame assembly 12 may be concealed by a plurality of body panels (not shown) and also supports other components of vehicle 10, such as portions of a driveline assembly, HVAC system, electrical components, a fuel tank, suspension systems, and any other component of vehicle 10.

Referring still to FIG. 1, frame assembly 12 also defines an interior or internal cabin space 16 of vehicle 10 which is configured to support the driver and a plurality of passengers therein. Internal cabin space 16 of vehicle 10 is internal to frame assembly 12 and internal to the body panels (not shown). Because vehicle 10 is illustratively shown as a commercial passenger bus, internal cabin space 16 must be maximized for increased numbers of passengers. As such, it may be necessary to support various components of vehicle 10 external to frame assembly 12 and the body panels (not shown). Unlike personal automobiles which are configured to be aesthetically-pleasing to the consumer by concealing various components of the vehicle, commercial busses, such as vehicle 10 of FIG. 1, are less concerned with aesthetics and more concerned with the utilitarian function of carrying large numbers of passengers and/or cargo. In this way, internal cabin space 16 may be maximized for increased numbers of passengers by moving various components of vehicle 10 to a position external to frame assembly 12.

In one embodiment, and as shown in FIG. 1, vehicle 10 is configured as a hybrid vehicle, a range-extended vehicle, or an electric vehicle. In this way, due to the ability of vehicle 10 to at least partially operate without the use of an engine, vehicle 10 may include an increased number of batteries 18 and/or include batteries 18 having an increased size. However, as noted above, it is necessary for internal cabin space 16 to be maximized to carry large numbers of passengers and, therefore, it may not be possible include batteries 18 within internal cabin space 16. Therefore, batteries 18 may be supported or mounted on a surface of vehicle 10 external to internal cabin space 16, frame assembly 12, and the body panels (not shown).

In one embodiment, batteries 18 of FIG. 1 include a plurality of batteries positioned on a roof portion 20 of vehicle 10, however, in other embodiments, batteries 18 may be externally positioned at a front or rear surface of vehicle 10, below vehicle 10, and/or along side portions of vehicle 10. Illustratively, each of batteries 18 is positioned in a side-by-side arrangement with adjacent batteries 18 such that a width 22 of batteries extends parallel to longitudinal axis L and a length 24 of batteries 18 extends perpendicular to longitudinal axis L. However, batteries 18 may be positioned in any type of arrangement on vehicle 10. Batteries 18 may be any type of battery suitable for use on a vehicle, such as lead-acid batteries or lithium-ion batteries. Batteries 18 may be connected in series and/or parallel, depending on the necessary application(s) thereof.

As shown in FIG. 1, batteries 18 are positioned within a battery enclosure, housing, frame, or box shown at 30 to support batteries 18 on vehicle 10. Battery enclosure 30 includes at least side portions 32 coupled to an upper surface 34 and a lower surface (not shown). The lower surface of battery enclosure 30 may be in contact with a portion of a body panel (not shown) of vehicle 10, for example a body panel of roof portion 20, and/or coupled to frame assembly 12. Side portions 32 extend vertically upwardly from the lower surface of battery enclosure 30 and are positioned above and external to the body panels defining roof portion 20 of vehicle 10. Additionally, upper surface 34 of battery enclosure 30 is positioned above and external to roof portion 20. In one embodiment, upper surface 34 may define a partial surface or rim extending around the perimeter of battery enclosure 30, however, in other embodiments, upper surface 34 may be defined as a single panel or a plurality of adjacent panels extending between all side portions 32 of battery enclosure 30 to define an upper cover thereof. Battery enclosure 30 is configured to support at least one battery 18 and, illustratively, is configured to support a plurality of adjacent batteries 18. Vehicle 10 may include one or more battery enclosures 30 on roof portion 20, each supporting one or more batteries 18 therein.

As shown in FIG. 1, because batteries 18 are positioned external to internal cabin space 16, frame assembly 12, and the body panels (not shown) of vehicle 10, batteries 18 are exposed to the external ambient conditions of the surrounding environment. For example, batteries 18 are exposed to sun-loading when the thermal load of the sun is applied to batteries 18 and low-temperature conditions when vehicle 10 is operating at cold temperatures and/or in ice and snow conditions. Therefore, batteries 18 are exposed to both the inherent thermal loading that occurs through operation of batteries 18 and/or other components of vehicle 10 adjacent to batteries 18 and the external thermal loading caused by the surrounding ambient and weather conditions. As such, there is a need to sufficiently manage the thermal loads of batteries 18 in view of the external location of batteries 18 on vehicle 10.

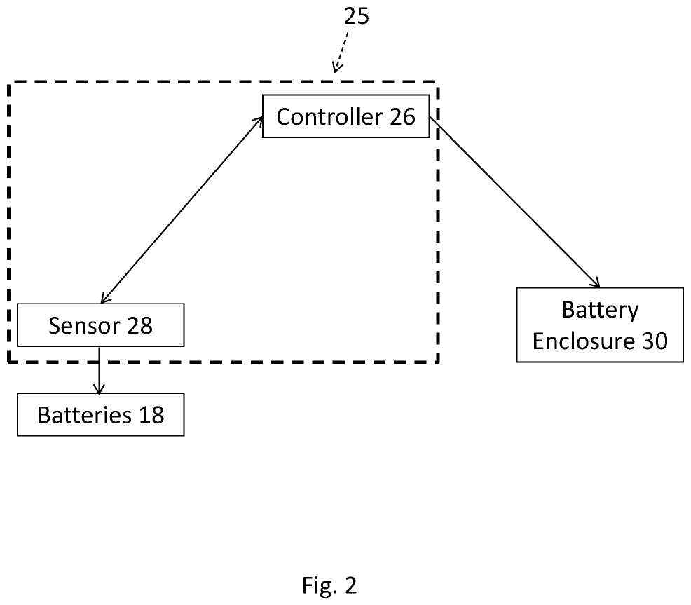

To address the thermal loads of batteries 18, especially the external thermal loads caused by sun-loading or low-temperature conditions, vehicle 10 includes a control system or assembly 25, as shown in FIG. 2. Control system 25 may be configured as a Battery Management System configured to control or manage thermal loads on batteries 18 and/or may be configured as at least a portion of the overall control system for vehicle 10.

Control system 25 includes a controller 26 and at least one sensor 28. Sensor 28 is operably coupled to batteries 18 and is configured to measure a current temperature of each of batteries 18. Sensor 28 also is operably coupled to controller 26 and is configured to transmit the temperature measurements of any of batteries 18 to controller 26. Controller 26 is configured to compare the current temperature measurement(s) of batteries 18 from sensor 28 to an optimal working or operating temperature range for batteries 18. If the current temperature measurement(s) of batteries 18 from sensor 28 indicates that the temperature of batteries 18 is above or below the optimal operating temperature range of batteries 18, then controller 26, which is operably coupled to battery enclosure 30 (FIG. 1), is configured to control at least one parameter of battery enclosure 30 to increase or decrease the temperature of batteries 18, as disclosed further herein. Additionally, if the current temperature measurement(s) of batteries 18 is within the optimal operating temperature range of batteries 18, then controller 26 is configured to manage the at least one parameter of battery enclosure 30 to maintain such a temperature range of batteries 18.

As disclosed herein, battery enclosure 30 may include a thermally-reactive portion in which such portion of battery enclosure 30 is configured to impact the external thermal load experienced by batteries 18. For example, the thermally-reactive portion of battery enclosure 30 may reflect or block external thermal loads, or absorb or otherwise allow external thermal loads, with respect to batteries 18. More particularly, the thermally-reactive portion may be a portion of battery enclosure 30 or may be removably coupled to a portion of battery enclosure 30. The thermally-reactive portion of battery enclosure 30 may be configured to control, with or without control system 25, external thermal loads from the sun or other external ambient conditions experienced by batteries 18.

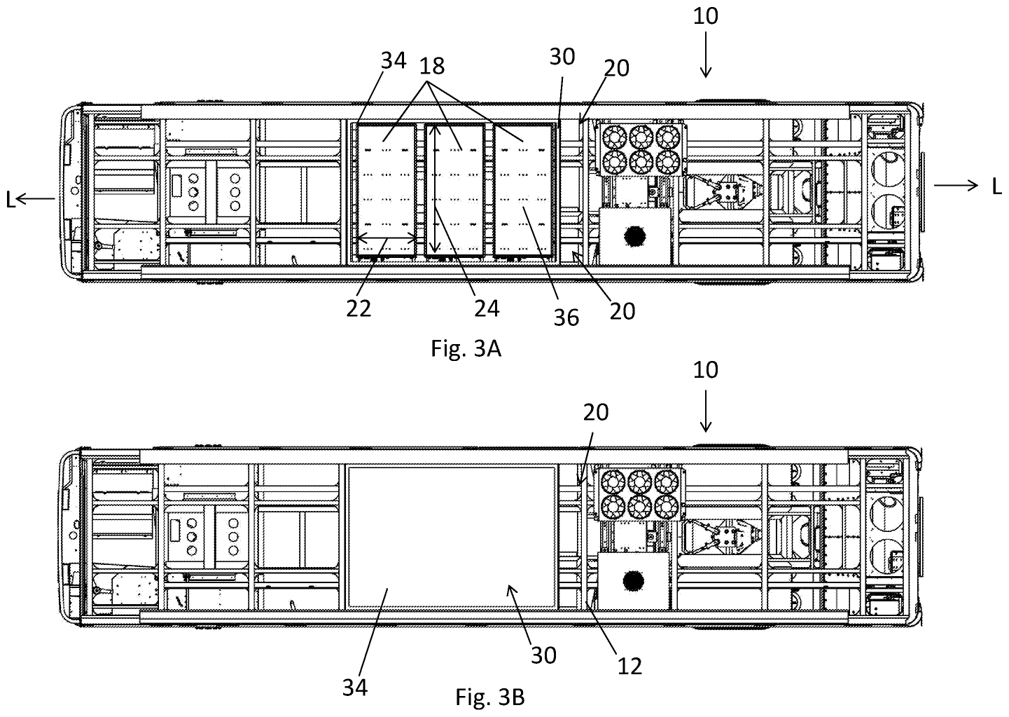

In one embodiment, and referring to FIGS. 3A and 3B, the thermally-reactive portion of battery enclosure 30 may be defined by upper surface 34 thereof. In the illustrative embodiment of FIGS. 3A and 3B, upper surface 34 of battery enclosure 30 includes a colored surface finish/treatment or colored surface panels which are configured to absorb or reflect thermal loads caused by the sun (i.e., sun-loading). The surface treatment and/or surface panels of upper surface 34 may be used in combination with a colored surface treatment of the cases of batteries 18 and/or the internal surface of side portions 32 and the lower portion (not shown) of battery enclosure 30.

For example, in one embodiment and as shown in FIG. 3A, upper surface 34 of battery enclosure 30 may define an open perimeter or rim of battery enclosure 30 such that the cases of batteries 18 are exposed to ambient conditions. Alternatively, upper surface 34 may define a physical cover or panel extending over battery enclosure 30 but which is transparent such that batteries 18 are visibly exposed therethrough. In regions of the world where ambient conditions are consistently cold, the cases of batteries 18, such as the top surfaces 36 thereof, may be treated with a dark color (e.g., black) to absorb heat caused by sun loading. In this way, upper surface 34 of battery enclosure 30 allows the dark color of top surfaces 36 of the battery cases to absorb any thermal load from the sun or other ambient conditions to increase the temperature of batteries 18 even when vehicle 10 is operating in consistently cold or low-temperatures.

Additionally, the internal surfaces of side portions 32 and/or the lower portion (not shown) of battery enclosure 30 also may include the dark-colored surface treatment to increase the thermal absorption from the sun and further increase the temperature of batteries 18 and/or maintain the temperature of batteries 18 within the optimal temperature range. The dark-colored surface treatment of top surfaces 36 of the battery cases and/or the internal surfaces of side portions 32 and the lower surface of battery enclosure 30 may be paint, an anodized metal treatment, a fixed or removable dark-colored panel (e.g., vinyl), or any other type of mechanism or member configured to apply a dark and thermally-absorbent color to batteries 18 and/or enclosure 30 to increase the thermal absorption when it is desirable to increase the temperature of batteries 18 (e.g., when vehicle 10 operates in a consistently low-temperature environment).

In a similar way, the embodiment of FIG. 3B shows that upper surface 34 of battery enclosure 30 is again defined as the thermally-reactive portion of battery enclosure 30. However, as shown in FIG. 3B, upper surface 34 defines a cover or panel that may be removably coupled to side portions 32 of battery enclosure 30 and is treated or otherwise covered with a light-colored or reflective surface treatment. This embodiment of upper surface 34 may be desirable when vehicle 10 operates in a consistently high-temperature environment, such that batteries 18 are consistently exposed to thermal loads which may increase the temperature thereof above an optimal temperature range for batteries 18.

As shown, upper surface 34 conceals batteries 18 and includes paint, anodized metal, fixed or removable panels (e.g., vinyl), or any other type of mechanism or member configured to apply a light-colored and/or thermally-reflective color to enclosure 30. In this way, upper surface 34 reflects, blocks, or otherwise prevents enclosure 30 from absorbing thermal loads from the sun which may negatively increase the temperature of batteries 18.

It may be appreciated that the embodiments of FIGS. 3A and 3B may include surface treated panels which may be removed from any portion of battery enclosure 30, including upper surface 34. Because such surface treated panels may be removed, it is possible for the embodiments of FIGS. 3A and 3B to be used on a vehicle 10 configured to operate in a variety of ambient conditions. For example, the dark-colored surface treatment of FIG. 3A may be utilized during low-temperature months, seasons, or conditions and subsequently removed as the ambient conditions and temperature increase. Additionally, the light-colored or reflective surface treatment of FIG. 3B may be utilized during high-temperature months, seasons, or conditions and subsequently removed as the ambient conditions change and the temperature decreases. In this way, various surface treatments or finishes of battery enclosure 30 and/or top surface 36 of the cases of batteries 18 allow for control and management of the external thermal loads on batteries 18.

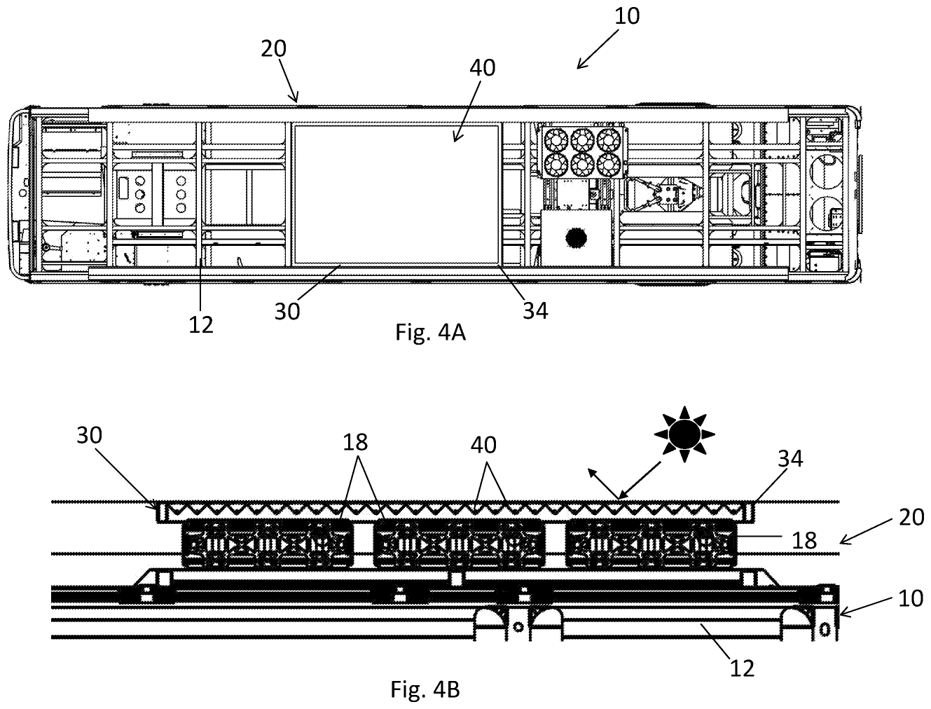

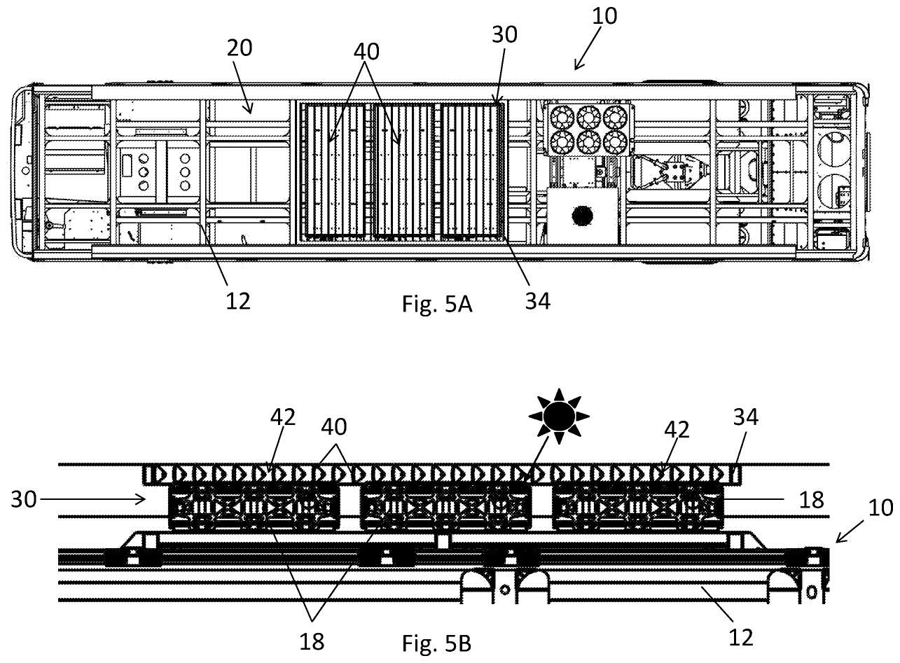

In one embodiment, and referring to FIGS. 4A-5B, the thermally-reactive portion of battery enclosure 30 may be defined by thermally-activated louvers 40. Thermally-activated louvers 40 may be supported by upper surface 34 of battery enclosure 30 and, illustratively, include a plurality of louvers 40 which are operably coupled together and configured to move with each other. More particularly, louvers 40 are configured to move between a closed position, as shown in FIGS. 4A and 4B, which reflects, blocks, or otherwise prevents thermal loads from the sun from being applied to batteries 18, and an open position, as shown in FIGS. 5A and 5B, which allows thermal loads from the sun to be applied to batteries 18 (i.e., sun-loading). Additionally, using control system 25 (FIG. 2), louvers 40 may be maintained in any position between the closed position of FIGS. 4A and 4B and the open position of FIGS. 5A and 5B. As such, louvers 40 may have a generally infinite number of positions ranging from a fully-closed position (FIGS. 4A and 4B) and a fully-open position (FIGS. 5A and 5B) which allows for batteries 18 to be fully sealed from the thermal loads of the sun, exposed to partial sun-loading when managing the temperature of batteries 18, and exposed to the full thermal load of the sun when it is necessary to increase and/or maintain the temperature of battery 18.

Louvers 40 are thermally-activated and will automatically open and close in response to a measured or sensed temperature of batteries 18. More particularly, louvers 40 are operably coupled to control system 25 (FIG. 2), including controller 26 and sensor 28. In this way, as sensor 28 measures a temperature of batteries 18 and transmits the measurement(s) to controller 26, controller 26 determines if the thermal load on batteries 18 should be reduced, increased, or maintained. To reduce the thermal load on batteries 18, controller 26 may send a command or otherwise actuate a motor (e.g., linked servo motors) and/or motor controller (not shown) of louvers 40 to automatically move louvers 40 to the closed position of FIGS. 4A and 4B in response to the sensed or measured temperature of batteries 18. When in the closed position, louvers 40 may continuously extend horizontally across upper surface 34 of battery enclosure 30 to fully conceal batteries 18 therein.

Additionally, to increase the external thermal load on batteries 18, for example when ambient conditions cause batteries 18 to be below the optimal operating temperature range, controller 26 may send a command or otherwise actuate the motor and/or motor controller of louvers 40 to automatically move louvers 40 to the open position of FIGS. 5A and 5B in response to the sensed or measured temperature of batteries 18. When in the open position, louvers 40 may extend in a generally vertical direction or may be angled to a degree relative to vertical such that a gap or spacing 42 is defined between adjacent louvers 40. Gaps 42 allow for the ambient conditions (e.g., rays from the sun or cold air) to penetrate battery enclosure 30 for cooling or heating batteries 18, respectively.

Also, when it is necessary to maintain or otherwise manage the current thermal load and temperature range of batteries 18, controller 26 may actuate louvers 40 to move to a position partially between the open position and the closed position to expose batteries 18 to a portion of the thermal load applied by the sun or other ambient conditions. In one embodiment, louvers 40 may be moved, depending on the position of the sun. For example, if it desirable to use the thermal load from the sun to increase the temperature of batteries 18, louvers 40 may be opened to a position which generally points toward the sun and allows for maximum sun-loading. As the position of the sun changes throughout the day, louvers 40 may be moved to adjust to the position of the sun when it is necessary to maximize sun-loading. A GPS device and/or clock may be included on control system 25 (FIG. 2) to determine the position of the sun.

Louvers 40 may be used in combination with a surface treatment to further control the external thermal loads experienced by batteries 18. More particularly, louvers 40 may have a surface treatment, such as paint, in a light or reflective color configured to reflect or otherwise block heat absorption into battery enclosure 30 when in the closed position of FIGS. 4A and 4B. Additionally, portions of battery enclosure 30, such as the internal surfaces of side portions 32 and the lower surface (not shown), may be coated or otherwise treated with a dark-colored surface treatment. In this way, when louvers 40 are moved to the open position of FIGS. 5A and 5B, the dark-colored surface treatment (e.g., paint) may absorb heat from the sun and/or the environmental conditions to increase the temperature of batteries 18 when desired.

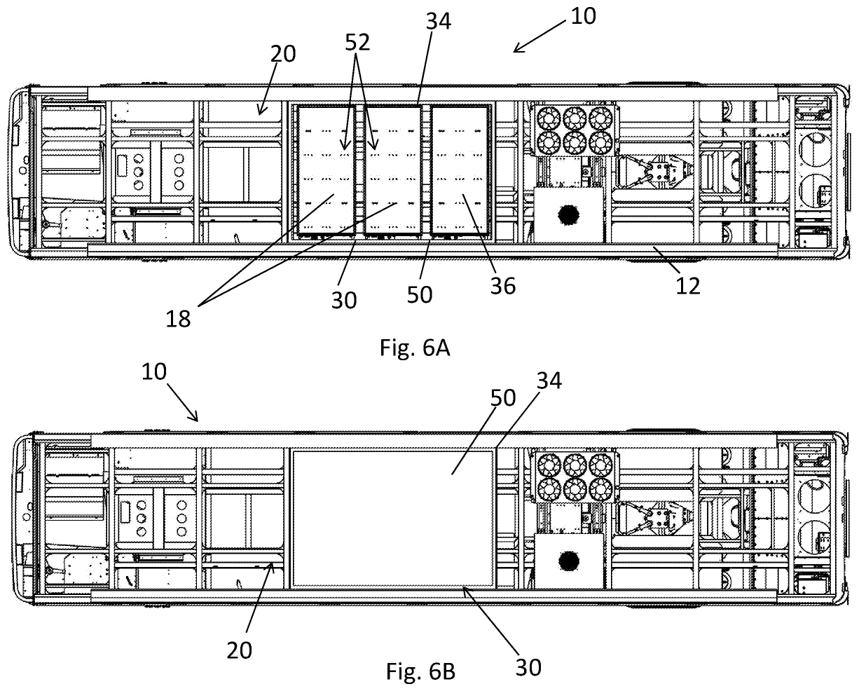

In one embodiment, and referring to FIGS. 6A-6B, the thermally-reactive portion of battery enclosure 30 may be defined by at least one thermally-activated window or panel 50. Illustratively, upper surface 34 of battery enclosure 30 may be defined as window 50, however, in other embodiments, upper surface 34 of battery enclosure 30 may define a perimeter or rim thereof and window 50 may be fixedly or removably coupled to upper surface 34. Window 50 is configured to be positioned above batteries 18 and, illustratively, is positioned above top surfaces 36 of the cases for batteries 18.

Window 50 is comprised of a switching material which controls the transparency level thereof. The switching material may be comprised of electrically-actuated cells 52 which respond to the presence and absence of an electrical charge. An example of the switching material comprising window 50 may be the LC Privacy Glass available from Innovative Glass Corporation of Plainview, N.Y. More particularly, the switching material allows window 50 to be in a transparent mode, as shown in FIG. 6A, in which the material comprising window 50 is transparent and batteries 18 are visible therethrough, or an opaque mode, as shown in FIG. 6B, in which the material comprising window 50 is opaque and batteries 18 are concealed and not visible therethrough. For example, when in the transparent mode, controller 26 may not actuate a charge through window 50 such that cells 52 therein are not energized and window 50 has 100% transparency in the transparent mode. However, when it is desirable to switch window 50 to the opaque mode, due to the sensed or measured temperature of batteries 18, controller 26 may actuate or energize a charge through cells 52 to cause a change in the cells resulting in 0% transparency through window 50 when in the opaque mode. As disclosed herein, windows are thermally-activated and will automatically switch between the transparent mode and the opaque mode in response to a measured or sensed temperature of batteries 18, as taken by sensor 28.

In this way, when the sensed or measured temperature of batteries 18, as determined by sensor 28, is within a first temperature range above the optimal temperature range for batteries 18, controller 26 may determine that batteries 18 should be concealed or prevented from experiencing the external thermal load from the sun and/or ambient conditions. In this instance, controller 26 may energize cells 52 to switch window 50 to the opaque mode in order to prevent penetration of the sun rays, for example, into battery enclosure 30. However, when the sensed or measured temperature of batteries 18, as determined by sensor 28, is in a second temperature range which is lower than the optimal temperature range for batteries 18, controller 26 may determine that the temperature of batteries 18 should be increased through sun-loading or other external thermal loads. In this instance, controller 26 may deactivate any charge applied to window 50 such that cells 52 are de-energized and window 50 switches to the transparent mode, thereby allowing sun-loading and other external thermal loads to be applied to batteries 18.

Window 50 may be used in combination with a surface treatment to further control the external thermal loads experienced by batteries 18. More particularly, portions of battery enclosure 30, such as the internal surfaces of side portions 32 and the lower surface (not shown) may be coated or otherwise treated with a dark-colored surface treatment. In this way, when window 50 is switched to the transparent mode of FIG. 6A, the dark-colored surface treatment (e.g., paint) may absorb heat from the sun and/or the environmental conditions to increase the temperature of batteries 18 when desired.

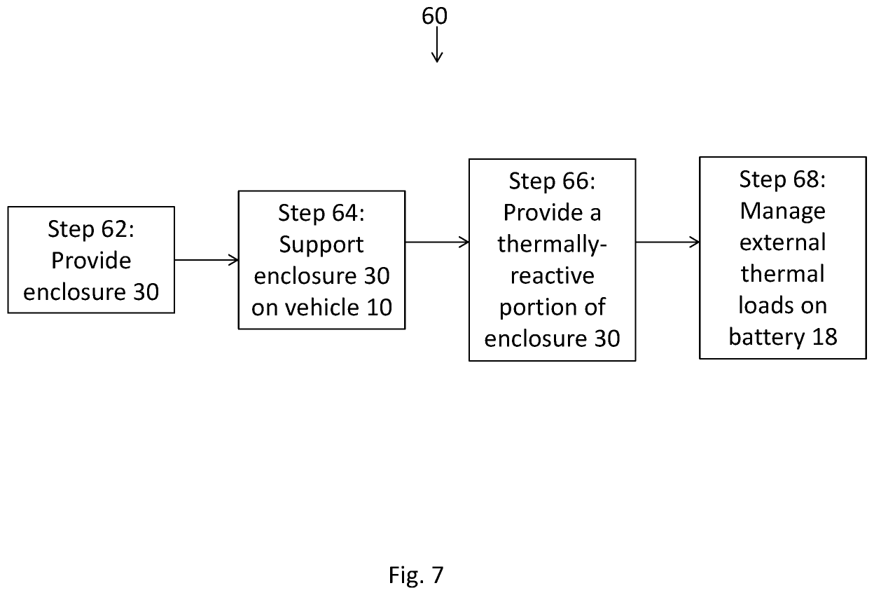

Referring to FIG. 7, a method 60 of controlling external thermal loads on batteries 18 is shown with Steps 62-68. More particularly, method 60 may be applicable to the embodiments disclosed herein because batteries 18 are supported externally on vehicle 10 and, therefore, are subject to external thermal loads, such as sun-loading and/or consistently low-temperature conditions. Especially in situations where batteries 18 are not cooled via water or some other mechanism, method 60 allows for controlling the external thermal loads on batteries 18 utilizing the embodiments disclosed herein. With method 60, it is possible to increase the temperature of batteries 18 to an optimal working temperature range when batteries 18 are in low-temperature conditions and it is possible to decrease the temperature of batteries 18 to the optimal working temperature range to prevent batteries 18 from overheating. If batteries 18 overheat, batteries 18 may de-rate, which leads to a decrease of power output from batteries 18 and decreases the life of batteries 18. Therefore, method 60 controls external thermal loads on batteries 18 to maintain the power output and increase the life thereof.

As shown in FIG. 7, method 60 includes Step 62 in which battery enclosure 30 is provided. As disclosed herein, battery enclosure 30 may define a housing, box, frame, or any other structure for supporting batteries 18 on vehicle 10. Step 64 includes supporting battery enclosure 30 on vehicle 10 and, due to the application of vehicle 10 (e.g., passenger and/or cargo vehicle), it may be necessary to support battery enclosure on an external surface of vehicle 10. In this way, batteries 18 supported within battery enclosure 30 are positioned externally to vehicle 10 and, therefore, may be exposed to external thermal loads (e.g., sun-loading, cold temperatures, etc.).

In order to manage or control the external thermal loads on batteries 18, a thermally-reactive portion of battery enclosure 30 is included in Step 66. More particularly, as disclosed in the embodiments herein, the thermally-reactive portion may include a light- or dark-colored surface treatment, as disclosed in FIGS. 3A and 3B, thermally-activated louvers 40, as disclosed in FIGS. 4A-5B, and/or at least one thermally-activated window 50, as disclosed in FIGS. 6A-6B. In this way, the thermally-reactive portion of battery enclosure 30 may be configured to absorb or block thermal loads with respect to batteries 18 to control or manage the temperature thereof.

More particularly, and as disclosed in Step 68, control system 25 (FIG. 2) may be used to manage, adjust, change, or otherwise control a parameter of the thermally-reactive portion of battery enclosure 30 to manage or control the external thermal loads experienced by batteries 18. For example, controller 26 (FIG. 2) may be configured to move thermally-activated louvers 40 (FIGS. 4A-5B) between (and including) the open position and the closed position to control the level of sun-loading or other external thermal loads applied to batteries 18 in order to control or manage the temperature of batteries 18. Additionally, controller 26 may be configured to energize or de-energize the switching material of thermally-activated window 50 (FIGS. 6A-6B) in order to provide window 50 in the opaque mode or the transparent mode to control or manage the temperature of batteries 18. Also, the thermally-reactive portion may include a surface treatment, such as dark- or light-colored panels, paint, or other surface or surface treatment to consistently absorb or reflect, respectively, the external thermal loads from the sun, for example. The surface treatment may be periodically removed from battery enclosure 30, depending on the season, length of ambient conditions, etc. in which vehicle 10 is operating.

While the embodiments have been described as having exemplary designs, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

1. A system for controlling external thermal loads on at least one battery for a vehicle, comprises:
a battery enclosure configured to support the at least one battery external to the vehicle, and the enclosure includes a thermally-reactive portion.

2. The system of claim 1, wherein the thermally-reactive portion is defined by an upper surface of the battery enclosure.

3. The system of claim 1, wherein the thermally-reactive portion defines a surface finish of a portion of the battery enclosure.

4. The system of claim 3, wherein the surface finish includes one of a light-colored finish applied to the portion of the battery enclosure, a reflective finish applied to the portion of the battery enclosure, or a dark-colored finish applied to the portion of the battery enclosure.

5. The system of claim 1, wherein the thermally-reactive portion defines thermally-activated louvers.

6. The system of claim 5, further comprising a controller and at least one sensor operably coupled to the controller and the battery enclosure, and the controller is configured to move the thermally-activated louvers in response to a measurement of the at least one sensor.

7. The system of claim 6, wherein the controller is configured to maintain the thermally-activated louvers in an open position, a closed position, and a plurality of intermediate positions between the open and closed positions.

8. The system of claim 5, wherein the battery enclosure includes a surface finish defining one of a light-colored finish applied to a portion of the battery enclosure, a reflective finish applied to the portion of the battery enclosure, or a dark-colored finish applied to the portion of the battery enclosure.

9. The system of claim 1, wherein the thermally-reactive portion defines at least one thermally-activated window configured to be transparent when in a first temperature range and configured to be opaque when in a second temperature range different than the first temperature range.

10. The system of claim 9, wherein the thermally-activated window include a thermally-activated switching material.

11. The system of claim 9, wherein the thermally-activated window defines an upper surface of the battery enclosure.

12. The system of claim 9, wherein the battery enclosure includes a surface finish defining one of a light-colored finish applied to a portion of the battery enclosure, a reflective finish applied to the portion of the battery enclosure, or a dark-colored finish applied to the portion of the battery enclosure.

13. A system for controlling external thermal loads on at least one battery for a vehicle, comprises:
a battery enclosure configured to support the at least one battery external to the vehicle, and the enclosure includes a thermally-reactive portion; and
a control system comprising a controller and at least one sensor operably coupled to the controller and the battery enclosure, and the controller is configured to adjust a parameter of the thermally-reactive portion of the battery enclosure.

14. The system of claim 13, wherein the thermally-reactive portion of the battery enclosure defines thermally-activated louvers and the controller is configured to move the thermally-activated louvers in response to a measurement of the at least one sensor.

15. The system of claim 14, wherein the controller is configured to maintain the thermally-activated louvers in an open position, a closed position, and a plurality of intermediate positions between the open and closed positions.

16. The system of claim 13, wherein the thermally-reactive portion of the battery enclosure defines at least one thermally-activated window and the controller is configured to adjust a level of transparency of the at least one thermally-activated window in response to a measurement of the at least one sensor.

17. A method of controlling external thermal loads on at least one battery for a vehicle, comprises:
providing an enclosure for the at least one battery;
supporting the enclosure on an external portion of the vehicle;
providing a thermally-reactive portion of the enclosure; and
managing external thermal loads on the at least one battery with the thermally-reactive portion.

18. The method of claim 17, wherein the thermally-reactive portion of the enclosure includes a surface finish on a portion of the enclosure, and the surface finish defines one of a light-colored finish applied to the portion of the battery enclosure, a reflective finish applied to the portion of the battery enclosure, or a dark-colored finish applied to the portion of the battery enclosure.

19. The method of claim 17, wherein the thermally-reactive portion of the enclosure includes one of thermally-activated louvers or at least one thermally-activated window, and managing external thermal loads on the at least one battery includes adjusting a parameter of the one of the thermally-activated louvers or the at least one thermally-activated window.

20. The method of claim 19, wherein adjusting the parameter of the thermally-activated louvers includes moving the thermally-activated louvers in an open position, a closed position, and a plurality of intermediate positions between the open and closed positions, and adjusting the parameter of the at least one thermally-activated window includes adjusting a transparency level of the at least one thermally-activated window.
